(19) United States
(12) Patent Application Publication
(10) Pub. No.: US 2004/0214059 A1
(43) Pub. Date: Oct. 28, 2004

(54) Fuel cell system

(76) Inventors: Naoyuki Enjoji, Utsunomiya-shi (JP); Yoshinori Wariishi, Utsunomiya-shi (JP); Norimasa Kawagoe, Utsunomiya-shi (JP)

Correspondence Address: FISH & RICHARDSON P.C., 45 ROCKEFELLER PLAZA, SUITE 2800, NEW YORK, NY, 10111, US

(21) Appl. No.: 10/833,284

(22) Filed: Apr. 27, 2004

(30) Foreign Application Priority Data
Apr. 28, 2003 (JP) 2003-123474

(51) Int. Cl. H01M 8/04

(52) U.S. Cl. 429/22; 429/23

(57) ABSTRACT

The concentration of a nitrogen gas in a circulatory supply passage connected to an anode is detected by a nitrogen concentration detector. Based on the detected concentration, the rotational speed of a pump disposed in the circulatory supply passage is controlled to adjust a hydrogen gas supplied to the anode in order to provide a desired stoichiometry for generating a target load current that is set by a target load current setting unit.

### BACKGROUND OF THE INVENTION

1. Field of the Invention

The present invention relates to a fuel cell system including fuel cells in which a fuel gas is supplied to an anode and an oxidizing gas containing a nitrogen gas is supplied to a cathode for generating electricity.

2. Description of the Related Art

For example, a solid polymer fuel cell employs a membrane electrode assembly (MEA) which includes two electrodes (anode and cathode), and an electrolyte membrane interposed between the electrodes. The electrolyte membrane is a polymer ion exchange membrane (proton exchange membrane). The membrane electrode assembly and separators sandwiching the membrane electrode assembly make up a unit of a fuel cell for generating electricity. Typically, a predetermined number of the fuel cells are stacked together to form a fuel cell stack.

FIG. 5 shows a general arrangement of a fuel cell system 2 employing a fuel cell stack 1 (see Japanese laid-open patent publication No. 2002-93438). In the fuel cell system 2, air as an oxidizing gas is supplied to the cathodes of the fuel cell stack 1. A hydrogen gas as a fuel gas is regulated by the pressure of air that is supplied to a pressure regulating valve 3, and then supplied through an ejector 4 to the anodes of the fuel cell stack 1. The hydrogen gas and the oxidizing gas are consumed in electrochemical reactions in the fuel cell stack 1 for generating electricity.

A hydrogen gas supply passage connected to the anodes serves as a circulatory supply passage for returning the supplied hydrogen gas to the ejector 4 via a valve 5. The circulatory supply passage circulates the hydrogen gas which has not consumed in the reaction in the fuel cell stack 1 for effectively utilizing the hydrogen gas.

A valve 6 is connected to the circulatory supply passage. When the valve 6 is opened, an unwanted gas accumulated in the circulatory supply passage is discharged from the fuel cell system 2 to the outside. Specifically, when the fuel cell stack 1 continuously operates to generate electricity, part of a nitrogen gas contained in the air supplied to the cathodes infiltrates toward the anodes and is mixed with the hydrogen gas, resulting in a reduction in the efficiency of generating electricity. Therefore, the valve 6 is opened as necessary to discharge the unwanted gas from the circulatory supply passage connected to the anodes.

When the unwanted gas is discharged from the anodes, part of the unconsumed hydrogen gas is also discharged from the fuel cell system 2. Therefore, the fuel economy of the fuel cell system 2 is lowered. When part of the unconsumed hydrogen gas is discharged as an exhaust gas, the concentration of the hydrogen gas in the exhaust gas needs to be lowered below a predetermined level. In order to minimize the amount of the discharged hydrogen gas, various operation tests have to be repeated on the fuel cell system 2 to determine the optimum condition for discharging the exhaust gas. In addition, the fuel cell system 2 is required to incorporate a means for lowering the concentration of the discharged hydrogen gas, e.g., a mechanism for diluting the hydrogen gas or a combustion mechanism for the hydrogen gas.

### SUMMARY OF THE INVENTION

It is a general object of the present invention to provide a fuel cell system which does not need to discharge gases from anodes and is capable of continuously generating electricity stably.

A major object of the present invention is to provide a fuel cell system which is simple in arrangement and inexpensive to manufacture.

Another major object of the present invention is to provide a fuel cell system which does not need a gas diluting means for diluting a hydrogen gas discharged from anodes.

Still another major object of the present invention is to provide a fuel cell system which has improved fuel economy and is capable of efficiently generating electricity.

Yet another major object of the present invention is to provide a fuel cell system which can be mounted on vehicles for generating desired electricity.

According to the present invention, the concentration of a fuel gas in a circulatory supply passage connected to an anode, or the concentration of a nitrogen gas contained in an oxidizing gas infiltrating from a cathode is detected, and a pump is controlled based on the detected concentration to adjust the amount of the fuel gas to be supplied, thereby keeping the fuel gas at a desired stoichiometry depending on a desired target load current for continuously generating electricity. The desired stoichiometry can be maintained for stable power generation without discharging the gas out of the circulatory supply passage. Throughout the specification and claims, the term “stoichiometry” indicates the value of a ratio of a supplied amount of a gas involved in a reaction to a consumed amount of the gas, and the term “desired stoichiometry” indicates a desired value of such a ratio.

A desired stoichiometry of the fuel gas may be determined based on a target load current set by a target load current setting unit, and the concentration of the fuel gas or the nitrogen gas which is detected by a concentration detector.

A valve may be disposed in the circulatory supply passage, and if the target load current is equal to or lower than a predetermined value, then the valve may be opened to discharge part of the fuel gas or the nitrogen gas from the circulatory supply passage. In this case, when a high target load current is set, a desired stoichiometry can easily be achieved for continuously generating electricity stably without actuating the pump to supply a large amount of fuel gas to the anode.

Alternatively, a relationship between target load currents and corresponding rotational speeds of the pump may be stored as a data table, and, based on data read from the data table, a desired stoichiometry can easily be achieved for continuously generating electricity stably without the need for detecting the concentration of the fuel gas or the nitrogen gas.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a block diagram of a fuel cell system according to an embodiment of the present invention;

FIG. 2 is a diagram showing the relationship between the nitrogen concentration (hydrogen concentration) in a circulatory supply passage in the fuel cell system according to the embodiment and the desired stoichiometry of a hydrogen gas;

FIG. 3 is a diagram showing the relationship between the target load current in the fuel cell system according to the embodiment and the desired stoichiometry depending on the nitrogen concentration;

FIG. 4 is a block diagram of a fuel cell system according to another embodiment of the present invention; and

FIG. 5 is a block diagram of a conventional fuel cell system.

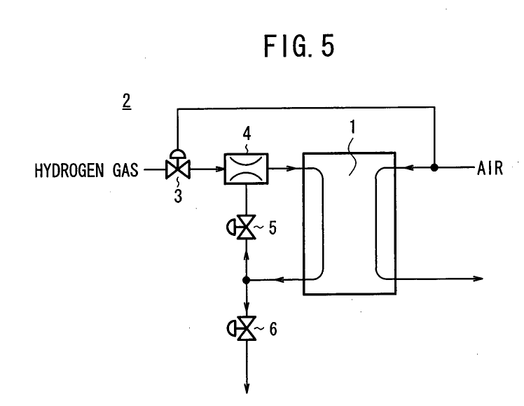

### DESCRIPTION OF THE PREFERRED EMBODIMENTS

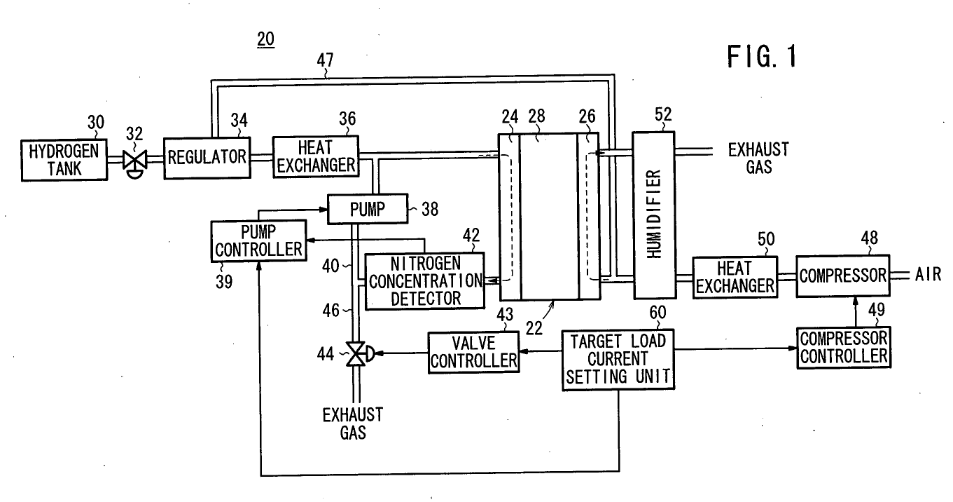

FIG. 1 shows in block form a fuel cell system 20 according to an embodiment of the present invention. In FIG. 1, double lines represent gas flow passages, and single lines represent electric signal lines.

The fuel cell system 20 includes a fuel cell stack 22 for generating electricity based on electrochemical reactions of a hydrogen gas as a fuel gas and air as an oxidizing gas. The fuel cell stack 22 comprises a large number of fuel cells each including an anode 24 supplied with the hydrogen gas, a cathode 26 supplied with the air, and an electrolyte membrane 28 as main components.

The hydrogen gas is supplied from a hydrogen tank 30 to an inlet of the anode 24 through a valve 32, a regulator 34, and a heat exchanger 36. The inlet of the anode 24 is connected to an outlet of the anode 24 by a circulatory supply passage 40. The circulatory supply passage 40 has a pump 38 for circulating the hydrogen gas discharged from the outlet of the anode 24 to the inlet of the anode 24, and a nitrogen concentration detector 42 for detecting the concentration of a nitrogen gas which is contained in the air filtrating from the cathode 26. A discharge passage 46 is connected to the circulatory supply passage 40 for discharging an exhaust gas to the outside when a valve 44 is opened. The valve 44 is selectively opened and closed by a valve controller 43.

The valve 32 is opened and closed according to a control signal depending on the starting and ending of power generation by the fuel cell stack 22. The pressure of the air supplied to the cathode 26 is transmitted as the back pressure to the regulator 34 through an air inlet passage 47. The pressure of the hydrogen gas is regulated based on the back pressure. The heat exchanger 36 adjusts the temperature of the hydrogen gas supplied to the anode 24 to a temperature that is optimum for generating electricity. The pump 38 is operated by the pump controller 39 to circulate the unconsumed hydrogen gas discharged from the outlet of the anode 24 to the inlet of the anode 24 through the circulatory supply passage 40.

The air is supplied to an inlet of the cathode 26 through a compressor 48, a heat exchanger 50, and a humidifier 52. As described above, the pressure of the air supplied to the inlet of the cathode 26 is transmitted as the back pressure via the air inlet passage 47 to the regulator 34. The cathode 26 has an outlet connected to the outside of the fuel cell system 20 through the humidifier 52.

The compressor 48 is operated by a compressor controller 49 to compress and supply the air to the heat exchanger 50. The heat exchanger 50 adjusts the temperature of the air supplied to the cathode 26 to a temperature that is optimum for generating electricity. The humidifier 52 humidifies the air with a moisture contained in a gas that is discharged from the cathode 26.

The fuel cell system 20 has a target load current setting unit 60 for setting a target load current to be generated by the fuel cell stack 22. The target load current that is set by the target load current setting unit 60 is supplied to the compressor controller 49, the pump controller 39, and the valve controller 43. The compressor controller 49 controls the compressor 48 according to the target load current to supply air under a given pressure to the cathode 26. The pump controller 39 controls the pump 38 according to the target load current and the nitrogen concentration detected by the nitrogen concentration detector 42 to supply a hydrogen gas at a desired stoichiometry depending on the target load current to the anode 24. The valve controller 43 selectively opens and closes the valve 44 according to the target load current to discharge the gas from the circulatory supply passage 40 via the discharge passage 46 out of the fuel cell system 20.

The fuel cell system 20 according to the present embodiment is basically constructed as described above. Operation of the fuel cell system 20 will be described below.

The target load current setting unit 60 sets a target load current to be generated by the fuel cell stack 22, and supplies information of the target load current to the pump controller 39, the valve controller 43, and the compressor controller 49.

The compressor controller 49 actuates the compressor 48 to supply the fuel cell stack 22 with compressed air that depends on and is required to generate the target load current. The air compressed by the compressor 48 is adjusted to a desired temperature by the heat exchanger 50, and supplied via the humidifier 52 to the inlet of the cathode 26.

The hydrogen gas, which is stored in a compressed state in the hydrogen tank 30, is supplied to the regulator 34 when the valve 32 is opened. The regulator 34 is supplied with the air from the cathode 26 via the air inlet passage 47. Therefore, the hydrogen gas supplied to the regulator 34 is adjusted in pressure by the pressure of the air that is regulated depending on the target load current and supplied as the back pressure, and is then supplied to the heat exchanger 36. The heat exchanger 36 adjusts the hydrogen gas to a desired temperature, and supplies the temperature-adjusted hydrogen gas to the inlet of the anode 24.

In the fuel cell stack 22, the hydrogen gas is supplied to the anode 24. The catalyst of the anode 24 induces a chemical reaction of the hydrogen gas to split the hydrogen molecule into hydrogen ions (protons) and electrons. The hydrogen ions move toward the cathode 26 through the electrolyte membrane 28, and the electrons flow through an external circuit to the cathode 26, creating electricity. At this time, the air is supplied to the cathode 26. An oxygen gas contained in the air reacts with the hydrogen ions supplied through the electrolyte membrane 28, and the electrons supplied through the external circuit to produce water.

The water produced at the cathode 26 and the air which has not consumed in the reaction are discharged as an exhaust gas from the fuel cell system 20 through the humidifier 52. At this time, the humidifier 52 humidifies the air supplied to the cathode 26 with water contained in the exhaust gas. Therefore, the electrolyte membrane 28 of the fuel cell stack 22 is humidified at an appropriate level by the water contained in the air. The water contained in the air and the water produced by the reaction are diffused toward the anode 24, humidifying the hydrogen gas. Therefore, the electrolyte membrane 28 is also humidified by the humidified hydrogen gas. As a result, the fuel cell stack 22 continuously generates electricity stably.

When the valve 44 is closed by the valve controller 43, the unconsumed hydrogen gas from the anode 24 is supplied again to the anode 24 through the circulatory supply passage 40 by the pump 38. Consequently, the hydrogen gas is effectively consumed for continuously generating electricity efficiently.

The fuel cell stack 22 is supplied with the air under pressure. Part of a nitrogen gas which is contained in the air and does not contribute to the generation of electricity infiltrates through the electrolyte membrane 28, and is gradually accumulated in the circulatory supply passage 40 connected to the anode 24. Though the fuel cell system 20 is designed so as to supply a hydrogen gas at a stoichiometry set for desired fuel economy through the regulator 34, if the concentration of the nitrogen gas introduced into the hydrogen gas unduly increases, then since the pressure in the circulatory supply passage 40 does not drop due to the partial pressure of the nitrogen gas even when the hydrogen gas is consumed by the fuel cell stack 22, the fuel cell system 20 fails to supply the hydrogen gas at a desired stoichiometry to the fuel cell stack 22.

According to the present embodiment, the concentration of the nitrogen gas in the circulatory supply passage 40 is detected by the nitrogen concentration detector 42, and the pump 38 is operated to maintain a desired stoichiometry of the hydrogen gas depending on the target load current and the nitrogen concentration.

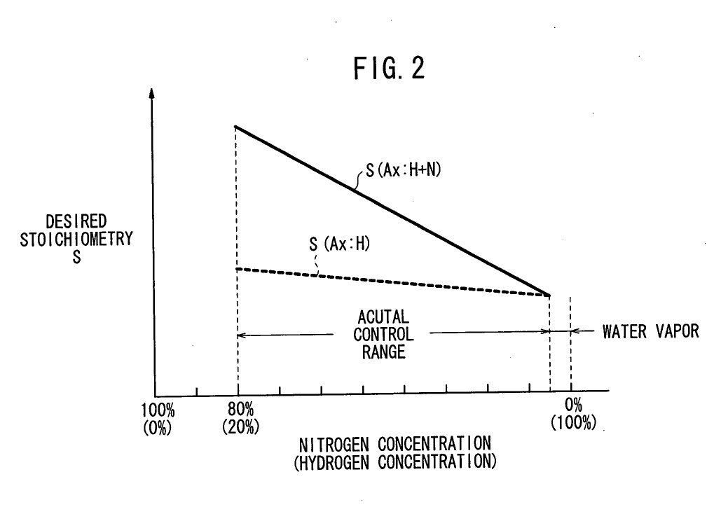

FIG. 2 shows the relationship between the desired stoichiometry (Ax:H) of the hydrogen gas in the circulatory supply passage 40 to achieve a certain target load current Ax and the nitrogen concentration in the circulatory supply passage 40. As indicated by the dotted-line in FIG. 2, as the nitrogen concentration increases, the desired stoichiometry S (Ax:H) also increases. The pump controller 39 controls the rotational speed of the pump 38 to obtain an apparent desired stoichiometry S (Ax:H+N) based on the concentrations of the hydrogen gas and the nitrogen gas, as indicated by the solid-line, depending on the desired stoichiometry (Ax:H) of the hydrogen gas.

For example, when the nitrogen concentration increases and the apparent desired stoidhiometry S (Ax:H+N) goes higher, the pump controller 39 increases the rotational speed of the pump 38 to increase the pressure in the inlet of the anode 24 and reduce the pressure in the outlet thereof. Due to the pressure difference, the regulator 34 supplies a required amount of hydrogen gas to the anode 24.

The water produced in the cathode 26 is present as a water vapor in the circulatory supply passage 40, and the concentration of the nitrogen gas contained in the air is about 80%. Therefore, an actual control range controlled by the pump 38 lies between the concentration of the water vapor and the upper-limit concentration of the nitrogen gas.

When the rotational speed of the pump 38 is thus controlled depending on the detected concentration of the nitrogen gas, if the target load current does not change such as the case of the fuel cell stack in a stationary application, then the target load current can stably be generated without discharging the nitrogen gas containing the hydrogen gas from the circulatory supply passage 40 through the discharge passage 46. Because no hydrogen gas is discharged out of the fuel cell system 20, the fuel cell system 20 requires no dedicated gas diluting means, and hence is simplified in structure and reduced in cost. The pump 38 and the circulatory supply passage 40 should preferably be designed for providing a desired flow rate when the maximum concentration of the nitrogen gas in the circulatory supply passage 40 is about 80%.

If the target load current is high, then since a large amount of air is supplied to the cathode 26, a correspondingly large amount of nitrogen gas infiltrates into the circulatory supply passage 40. The anode 24 is also supplied with a large amount of hydrogen gas. In order to achieve a desired stoichiometry of the hydrogen gas under such a circumstance, not only the pump 38 has to have a sufficiently large ability to circulate the gas, but also the gas flow passages including the circulatory supply passage 40 have to be large in size. However, if the gas flow passages are large in size, then the hydrogen gas supplied to the fuel cell stack 22 under a low load flows at too a low rate, possibly failing to generate electricity stably.

If the fuel cell system 20 is applied to a system where the target load current varies, e.g., in a vehicle-mounted fuel cell system, then it is desirable to operate the fuel cell system 20 in a purgeless control mode wherein the nitrogen gas containing the hydrogen gas is not discharged out of the fuel cell system 20 when it is under a low load, e.g., when the vehicle is warming up for starting to move or idling, and in a purge control mode wherein the valve 44 is opened at given timing to discharge the nitrogen gas containing the hydrogen gas out of the fuel cell system 20 from the discharge passage 46 when the fuel cell system 20 is under a high load.

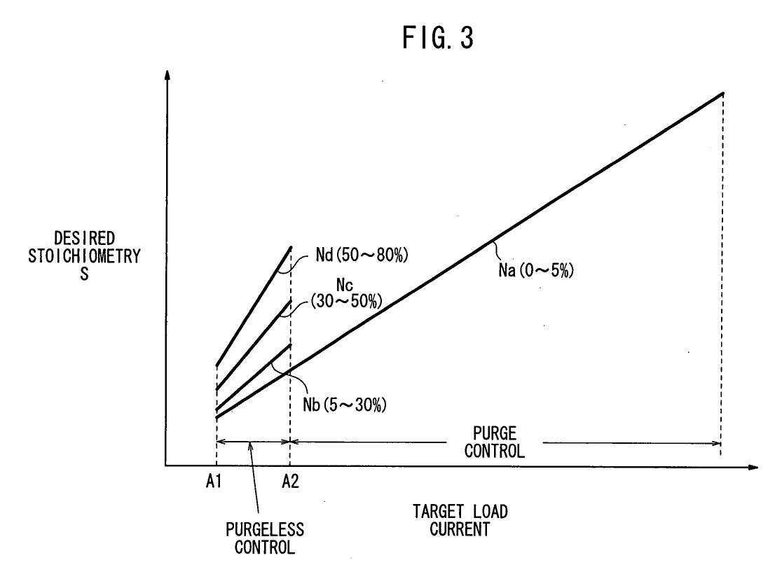

FIG. 3 is a diagram illustrative of a process of switching between the purgeless mode and the purge mode depending on the target load current. In FIG. 3, the concentration of the nitrogen gas in the circulatory supply passage 40 is divided into ranges Na (0-5%), Nb (5-30%), Nc (30-50%), and Nd (50-80%), and apparent desired stoichiometries S of the nitrogen gas containing the hydrogen gas are set up for the respective ranges with respect to the target load current set by the target load current setting unit 60. The concentration of the nitrogen gas may not be divided into those ranges, and apparent desired stoichiometries S may be set for respective levels of the concentration of the nitrogen gas.

When the fuel cell system 20 is under a low load represented by the target load current in a range A1-A2, the valve controller 43 closes the valve 44 to shut the discharge passage 46, and the compressor 49 controls the compressor 48 according to the target load current to supply air to the cathode 26 and supply a hydrogen gas to the anode 24. In this state, the pump controller 39 controls the pump 38 to supply the anode 24 with the hydrogen gas at a desired stoichiometry based on the concentration of the nitrogen gas detected by the nitrogen concentration detector 42. As a result, the fuel cell system 20 can generate electricity stably without discharging the hydrogen gas out of the fuel cell system 20.

When the fuel cell system 20 is under a high load represented by the target load current in a range higher than A2, the valve controller 43 opens the valve 44 at given intervals to discharge the nitrogen gas from the circulatory supply passage 40 from the discharge passage 46. At this time, since the nitrogen gas is discharged, the concentration of the hydrogen gas in the circulatory supply passage 40 increases. Therefore, the desired target load current can be generated at the desired stoichiometry without rotating the pump 38 to resupply the hydrogen gas.

In the above embodiment, the concentration of the nitrogen gas is detected by the nitrogen concentration detector 42 to control the rotational speed of the pump 38. However, since the nitrogen concentration and the hydrogen concentration are complementary to each other as shown in FIG. 2, the hydrogen concentration may be detected to control the rotational speed of the pump 38.

In the above embodiment, the nitrogen concentration in the circulatory supply passage 40 is detected by the nitrogen concentration detector 42, and the rotational speed of the pump 38 is controlled to supply a hydrogen gas at a desired stoichiometry based on the detected nitrogen concentration. However, it is possible to control the pump 38 to achieve a desired stoichiometry without having to detect the nitrogen concentration and the hydrogen concentration.

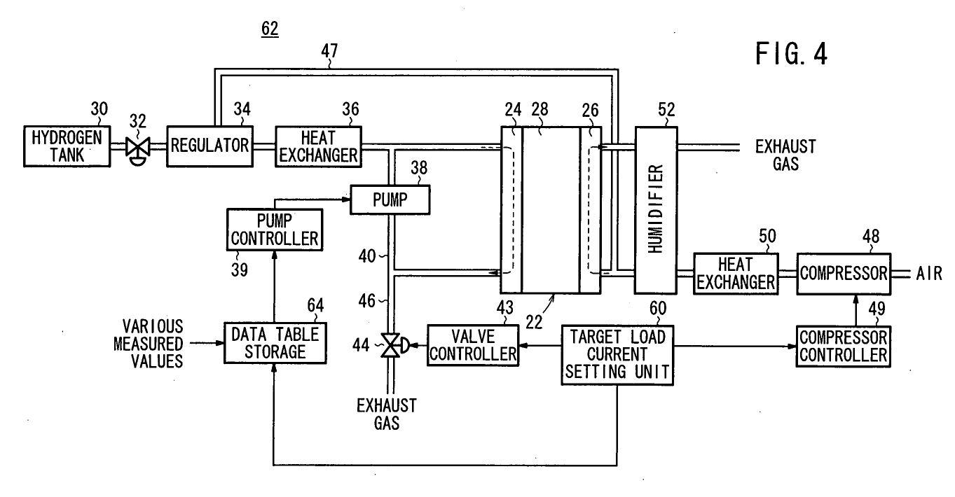

For example, in an operation range of a fuel cell system 62 shown in FIG. 4, nitrogen concentrations or hydrogen concentrations in the circulatory supply passage 40 are set for respective values (e.g., at intervals of 1 A) of the target load current. While the fuel cell system 62 is in operation to generate electricity, rotational speeds of the pump 38 for achieving desired stoichiometries for stable power generation, pressures, flow rates, and temperatures of the hydrogen gas at the outlet of the regulator 34 at those rotational speeds, and pressures, flow rates, and temperatures of the gas at the outlet of the pump 38 at those rotational speeds are measured, and the measured data are associated and stored as a data table in a data table storage 64. When the fuel cell system 62 is operated to generate electricity, the data table stored in the data table storage 64 is referred to based on a set target load current and measured pressure, flow rate, and temperature values to determine a rotational speed of the pump 38 for achieving a desired stoichiometry, and the pump 38 is actuated based on the determined rotational speed. In this manner, the nitrogen concentration detector 42 or the non-illustrated hydrogen concentration detector may be dispensed with, and general pressure sensors, flow rate sensors, and temperatures sensors may be employed to optimally control the fuel cell system 62 to achieve a desired stoichiometry with a relatively inexpensive arrangement.

Even in a transient situation where the target load current abruptly changes, changes in the amount of hydrogen gas supplied from the regulator 34 and changes in the amount of hydrogen gas consumed by the fuel cell stack 22 are measured for the respective conditions described above, and the measured data are stored as a data table for stable power generation. Using data read from the data table thus stored, the fuel cell system can be more optimally controlled to achieve a desired stoichiometry. The amount of hydrogen gas supplied from the regulator 34 can easily be estimated from the pressure, flow rate, and temperature of the hydrogen gas at the outlet of the regulator 34. The amount of hydrogen gas consumed by the fuel cell stack 22 can be calculated from the value of the generated load current.

Although certain preferred embodiments of the present invention have been shown and described in detail, it should be understood that various changes and modifications may be made therein without departing from the scope of the appended claims.

What is claimed is:

1. A fuel cell system comprising:
a fuel cell having an anode and a cathode, for generating electricity with a fuel gas supplied to the anode and an oxidizing gas containing a nitrogen gas supplied to the cathode;
a circulatory supply passage for circulating said fuel gas discharged from said fuel cell to said anode;
a pump disposed in said circulatory supply passage for circulating said fuel gas;
a concentration detector for detecting the concentration of said fuel gas in said circulatory supply passage or the concentration of said nitrogen gas infiltrating from said cathode into said circulatory supply passage; and
a pump controller for controlling said pump to operate based on said concentration detected by said concentration detector to regulate said fuel gas supplied to said anode according to a desired stoichiometry.

2. A fuel cell system according to claim 1, wherein said pump controller controls said pump to achieve an apparent desired stoichiometry based on the concentrations of said fuel gas and said nitrogen gas in said circulatory supply passage.

3. A fuel cell system according to claim 1, further comprising:
a target load current setting unit for setting a target load current to be generated by said fuel cell;
wherein said pump controller controls said pump according to said desired stoichiometry at said concentration which is capable of achieving said target load current.

4. A fuel cell system according to claim 3, further comprising:
a valve for discharging a gas circulated in said circulatory supply passage out of the circulatory supply passage; and
a valve controller for selectively opening and closing said valve;
wherein if said target load current is equal to or lower than a predetermined value, said valve controller closes said valve and said pump controller controls said pump to operate, and if said target load current is greater than said predetermined value, said valve controller opens said valve at given timing to discharge part of the gas out of the circulatory supply passage.

5. A fuel cell system according to claim 1, wherein said fuel cell comprises a vehicle-mounted fuel cell.

6. A fuel cell system according to claim 1, wherein said fuel cell comprises a stationary fuel cell.

7. A fuel cell system comprising:
a fuel cell having an anode and a cathode, for generating electricity with a fuel gas supplied to the anode and an oxidizing gas containing a nitrogen gas supplied to the cathode;
a circulatory supply passage for circulating said fuel gas discharged from said fuel cell to said anode;
a pump disposed in said circulatory supply passage for circulating said fuel gas;
a target load current setting unit for setting a target load current to be generated by said fuel cell;
a data table storage for storing a data table representing a relationship between target load currents, measured values of the pressure, flow rate, and temperature of said fuel gas, and rotational speeds of said pump; and
a pump controller for controlling said pump to operate according to a rotational speed read from said data table stored in said data table storage based on the target load currents and the measured values to regulate said fuel gas supplied to said anode according to a desired stoichiometry.
